(19) United States
(12) Patent Application Publication
(10) Pub. No.: US 2016/0132033 A1
(43) Pub. Date: May 12, 2016

(54) MACHINE TOOL POWER CONSUMPTION PREDICTION SYSTEM AND METHOD

(71) Applicant: INSTITUTE FOR INFORMATION INDUSTRY, Taipei (TW)

(72) Inventors: Chih-Chiang Kao, Taoyuan City (TW); Chih-Yi Wu, Yilan City (TW); Yung-Yi Huang, Puli Township (TW); Cheng-Hui Chen, Mingjian Township (TW); Hung-Sheng Chiu, Taipei City (TW)

(21) Appl. No.: 14/695,105

(22) Filed: Apr. 24, 2015

(30) Foreign Application Priority Data
Nov. 6, 2014 (TW) 103138564

(51) Int. Cl. G05B 19/048

(52) U.S. Cl. CPC G05B 19/048; G05B 2219/23102; G05B 2219/2639

(57) ABSTRACT

The present disclosure provides a machine tool power consumption prediction system configured for predicting power consumption of a machine tool. The machine tool executes numerical control programs to produce parts, and various parameters are included in each of the numerical control programs. The machine tool power consumption prediction system includes a power consumption database and a computer. The power consumption database stores power consumption data associated with different values of the parameters included in the numerical control programs. The computer is connected to the power consumption database to retrieve the power consumption data, and generates a power consumption estimate associated with each of the numerical control programs to be executed by the machine tool.

### RELATED APPLICATIONS

This application claims priority to Taiwan Application Serial Number 103138564, filed Nov. 6, 2014, which is herein incorporated by reference.

### BACKGROUND

1. Field of Invention

The present disclosure relates to a machine tool power consumption prediction system and method. More particularly, the present disclosure relates to a system and method for predicting power consumption according to numerical control (NC) programs and machining parameters associated with machine tools.

2. Description of Related Art

Cost control is a key ability for enterprises to earn profits. Electricity cost is an important part of the processing cost for manufacturing industries, especially for machine tools. A production factory owner signs a long-term energy contract with electricity providers to get a lower electricity rate. A long-term energy contract specifies an upper threshold value for electric quantity and electricity rates, and production factory owner is faced with a huge fine or a steep increase in the electricity rate when power consumption of the production factory exceeds the upper threshold value specified in the long-term contract.

Therefore, many production factory owners introduce smart electricity meters to monitor and control total power consumption of the production factories according to the monitoring results of the smart electricity meters, so as to avoid the total power consumption to exceed the upper threshold value. However, the above solution only provides a way to control the total power consumption, but interferes with the production and manufacturing schedule. For example, the production volumes of the production factories vary from month to month, and power consumption also varies parts to be produced. Moreover, the production factories have to pay the fine or purchase power generators to increase production for extra demand of the clients.

### SUMMARY

An aspect of the present disclosure is directed to a machine tool power consumption prediction system for predicting power consumption for at least one machine tool. The machine tool is configured for executing at least one numerical control program to produce a part, and each aforesaid numerical control program includes multiple machining parameters. The machine tool power consumption prediction system includes a power consumption database and a computer. The power consumption database is configured for storing multiple power consumption data associated with different values of the machining parameters included in the numerical control program. The computer is electrically connected with the power consumption database and is configured for generating a power consumption estimate associated with the numerical control program by obtaining the power consumption data associated with the values of the machining parameters from the power consumption database according to the values of the machining parameters included in the numerical control program to be executed by the machine tool.

Another aspect of the present disclosure is directed to a machine tool power consumption prediction method for predicting power consumption for at least one machine tool. The machine tool is configured for executing at least one numerical control program to produce a part, and each aforesaid numerical control program includes a plurality of machining parameters. The power consumption prediction method includes the following steps: storing multiple power consumption data associated with different values of the machining parameters included in the numerical control program; generating a power consumption estimate associated with the numerical control program by obtaining the power consumption data associated with the values of the machining parameters from the power consumption database according to the values of the machining parameters included in the numerical control program to be executed by the machine tool.

It is to be understood that both the foregoing general description and the following detailed description are by examples, and are intended to provide further explanation of the present disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a machine tool power consumption prediction system according to a first embodiment of the present disclosure;

FIG. 2 is schematic diagram of a machine tool power consumption prediction system according to a second embodiment of the present disclosure;

FIG. 3 is flow chart of a machine tool power consumption prediction method according to a third embodiment of the present disclosure;

FIG. 4 is flow chart of a machine tool power consumption prediction method according to a fourth embodiment of the present disclosure; and

FIG. 5 is a schematic diagram of a machine tool power consumption prediction system according to a fifth embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Production factories for producing parts often sign long-term contracts with electricity providers, and production factory owners agree to an upper threshold value for electric quantity for a time interval, e.g., a month, specified in the contracts to enjoy a lower electricity rate. When power consumption of the production factory exceeds the upper threshold value, the production factory owner is faced with a huge fine. When the power consumption of the production factory is below the upper threshold value, the production factory owner still has to pay for the contracts. Therefore, the key to cost control is to accurately predict the power consumption of production process, so as to set a reasonable upper threshold value. The present disclosure provides a machine tool power consumption prediction system and method to help the production factory owner by accurately predicting the power consumption of the production process and generating an execution schedule that reduces the cost for production.

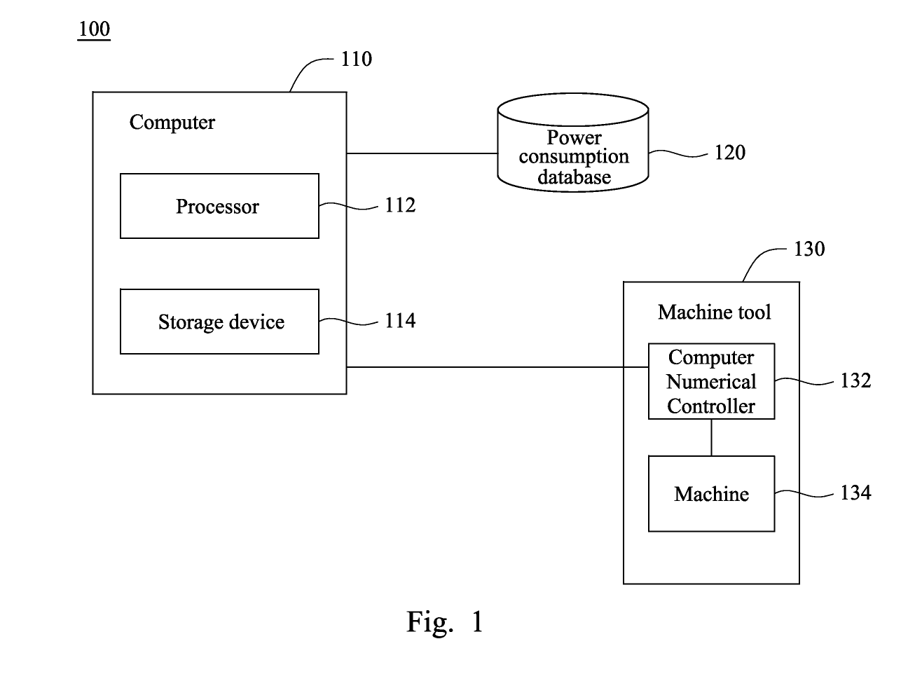

FIG. 1 is a schematic diagram of a machine tool power consumption prediction system according to a first embodiment of the present disclosure. The machine tool power consumption prediction system 100 includes a computer 110 and a power consumption database 120. The computer 110 is electrically connected to the power consumption database 120 and one or more machine tools 130. Each of the machine tools 130 includes a computer numerical controller 132 and a machine 134. The computer numerical controllers 132 read numerical control programs and control tool spindles and tables of the machines 134 according to the numerical control programs and machining parameters included in the numerical control programs. Illustratively, the computer 110 serves as a control center and is electrically connected with the computer numerical controllers 132 in the machine tools 130 to transmit the numerical control programs to the computer numerical controllers 132, so as to cause the computer numerical controllers 132 to execute the numerical control programs. One machine tool 130 is shown in FIG. 1 to represent multiple machine tools 130. The machine tool power consumption prediction system 100 is configured for predicting power consumption of the machine tool 130 included, and the machine tools 130 are configured for producing parts by executing the one or more numerical control programs, and each of the numerical control programs includes multiple machining parameters.

The computer 110 is a server, a workstation, or a personal computer. The processor 112 is a central processing unit or a microcontroller. The storage device 114 is a hard disk, an optical disc, or a flash memory.

The power consumption database 120 can be stored in a storage device, such as a hard disk, any non-transitory computer readable storage medium, or a database accessible from network. Those of ordinary skill in the art can think of the appropriate implementation of the power consumption database 120 without departing from the spirit and scope of the present disclosure.

The machine tools 130 are configured for precisely cutting metal to produce parts by generating a relative motion between a tool spindle and a table. The relative motion includes a spindle motion of the tool spindle and a feed motion of the table on which the parts are placed. The computer numerical controllers 132 control the two motions to produce the parts. The machine tools 130 are used for shaping, cutting, and connecting, and the types of the machine tools 130 include lathes, mills, grinders, and drilling machine. In one embodiment, the machine tool 130 is a computer numerical control (CNC) machine tool.

The power consumption database 120 is configured for storing the numerical control programs and the power consumption data associated with the numerical control programs and different values of the machining parameters included in the numerical control programs. The machining parameters include a spindle speed, a feed rate, and depth of cut. The power consumption database 120 is configured for storing the power consumption data associated with different values of the machining parameters of each of the numerical control programs. For example, the power consumption database 120 records the power consumption data as 15 kW (kilowatt) associated with a first numerical control program executed with the spindle speed as 0-600 rpm (rev per minute), and the time for producing one piece is 2 minutes; and the power consumption database 120 records the power consumption data as 20 kW associated with the first numerical control program executed with the spindle speed as 600-1000 rpm, and the time for producing one piece is 1.5 minutes. The power consumption database 120 also records the power consumption data associated with the other numerical control programs. For example, a second numerical control program is associated with the power consumption data as 5 kW and the time taken to produce one piece is 3 minutes when the second numerical control program is executed with the spindle speed as 0-300 rpm, and also with the power consumption data 12 kW and the time taken to produce one piece as 2 minutes when the second numerical control program is executed with the spindle speed as 300-600 rpm. In the aforementioned examples, the power consumption database 120 is configured for storing the power consumption data as the power and time for finishing one piece as the power consumption data associated with the different values of the machining parameters. In another embodiment, the power consumption database 120 is configured for storing the power consumption of finishing one piece of the parts. The numbers are only by example and the scope of the present disclosure is not limit hereto. Those who are skilled in the art can design data formats of the power consumption data stored in the power consumption database 120 without departing from the spirit and scope of the present disclosure.

The computer 110 is electrically connected to the power consumption database 120, and is configured for generating a power consumption estimate associated with the numerical control programs by obtaining the power consumption data associated with the values of the machining parameters from the power consumption database 120 according to the values of the machining parameters included in the numerical control programs to be executed by the machine tool 130. For example, the machine tool 130 is configured for executing one of the numerical control programs including the machining parameters of the spindle speed as 300 rpm, the feed rate as 5 mm/rev, and the depth of cut as 10 mm, and the computer 110 is configured for searching the power consumption database 120 according to the values of the machining parameters described above to generate a power consumption estimate associated with producing one piece of the parts as 0.01 kilowatt hour. The numbers are only by example and the scope of the present disclosure is not limit hereto.

The computer 110 is configured for generating the power consumption estimates with the power consumption data associated with the different values of the machining parameters, and thus yields more accurate results than the conventional method in which the production factories are monitored as a whole. The production factory owners make energy plans according to the accurate power consumption estimate, so as to save the electricity cost for production.

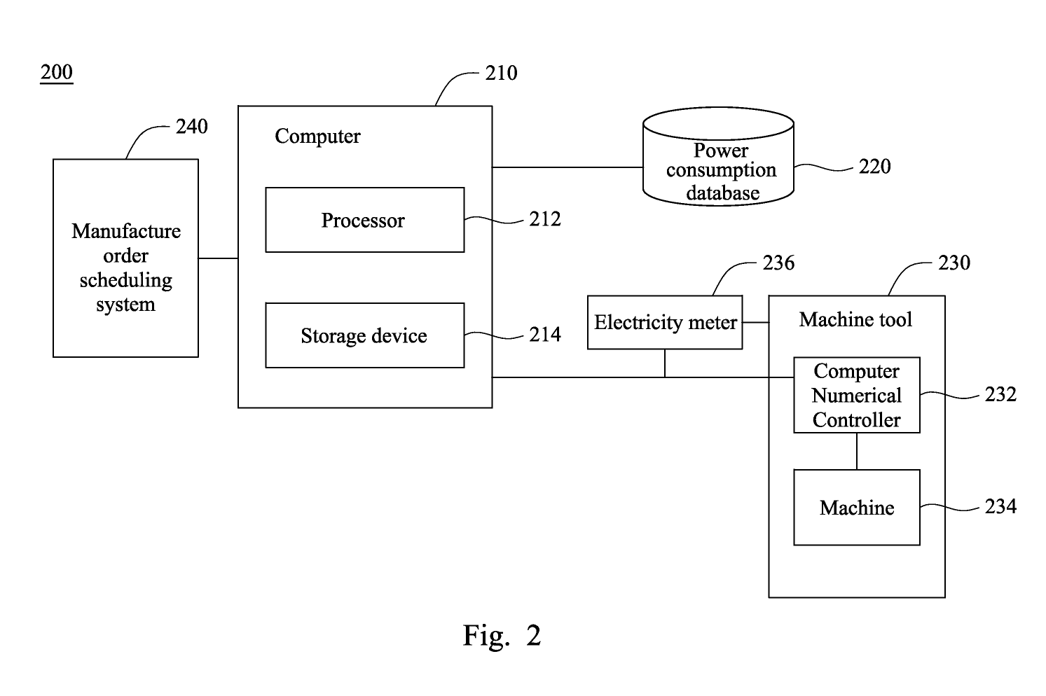

FIG. 2 is schematic diagram of a machine tool power consumption prediction system according to a second embodiment of the present disclosure. A machine tool power consumption prediction system 200 is configured for generating the power consumption estimates according to the power consumption data associated with the various values of the machining parameters and further generating an execution schedule that reduces electricity cost according to the power consumption estimates. Moreover, when the power consumption estimate exceeds an upper threshold value, the machine tool power consumption prediction system 200 is also configured for providing recommended values for the machining parameters to reduce the power consumption to be lower than the upper threshold value of electricity usage or generating an warning for the production factory owners to evaluate whether the profits from producing parts outweighs the fine from consuming more power than the upper threshold value.

The machine tool power consumption prediction system 200 includes a computer 210, a power consumption database 220, and multiple machine tools 230. The computer 210 includes a processor 212 and a storage device 214. The connection and interoperation of the components are similar to the components shown in FIG. 1, and the details are not repeated herein. The machine tool power consumption prediction system 200 further includes a manufacture order scheduling system 240 connected to the computer 210. The computer 210 is configured for obtaining a schedule for the machine tools 230, and the schedule includes numerical control programs to be executed by the machine tools 230. In some embodiments, electricity meters 236 are respectively installed in each of the machine tools 230 in the machine tool power consumption prediction system 200. Each of the electricity meters 236 is electrically connected with the computer 210. The computer 210 is configured for receiving electricity consumption from the electricity meters 236 to add, modify, and update the power consumption data associated with the values of the machining parameters and the numerical control programs.

The manufacture order scheduling system 240 is configured for storing multiple manufacture orders, and each of the manufacture orders includes the part names, amounts of the parts to be produced, raw materials for producing the parts, and delivery dates, etc. The manufacture order scheduling system 240 is configured for planning a schedule associated with the machine tools 230, and the computer 210 electrically connected with the manufacture order scheduling system 240 is configured for obtaining the schedule and the multiple numerical control programs to be executed in the schedule. In one embodiment, the manufacture order scheduling system 240 is an advanced planning and scheduling system (APS) connected with the computer 210 via a network. In another embodiment, the manufacture order scheduling system 240 and the computer 210 are installed in the same server, workstation, or personal computer.

According to the accompanying text of FIG. 1, the computer 210 is configured for generating the power estimates associated with each of the numerical control programs to be executed according to the power consumption data stored in the power consumption database 220 and the values of the machining parameters included in the numerical control programs. The computer 210 further includes the upper threshold value, and is configured to generate an execution schedule and the power consumption estimate associated with the execution schedule according to the schedule, the numerical control programs to be executed, the upper threshold value, and the power consumption estimates corresponding to the schedule and the numerical control programs to be executed. The machine tools 230 are configured for producing the parts according to the execution schedule, and the power consumption estimate associated with the execution schedule is controlled to be lower than the upper threshold value. In other words, the computer 210 is configured for receiving the schedule including the numerical control programs to be executed, adjusting the schedule according to the upper threshold value and the power consumption estimates associated with the numerical control programs or adjusting the values of the machining parameters to generate the execution schedule, and calculating the power consumption estimate associated with the execution schedule, and the power consumption estimate associated with the execution schedule is lower than the upper threshold value. Furthermore, the computer 210 is configured for generating multiple alternative schedules, calculating the power consumption estimates associated with each of the alternative schedules, and choosing the alternative schedule with the lowest power consumption estimate as the execution schedule. In some embodiment, the computer 210 is configured for adjusting the values of the machining parameters to reduce the power consumption estimates associated with the numerical control programs and then adjusting the schedule.

In one embodiment, the schedule is a working schedule including the numerical control programs to be executed by the machine tools 230 during a day, and the upper threshold value is a power consumption threshold value for every 15-minute interval. The computer 210 is configured for generating the execution schedule and the power consumption estimate associated with the execution schedule and transmits the execution schedule to the computer numerical controller 232, so as to get a total power consumption value for every 15-minute interval to be below the power consumption threshold value. Moreover, the computer 210 is configured for generating a warning when the total power consumption value for any 15-minute interval is not to be lower than the power consumption threshold value. The warning generated by the computer 210 can be a warning sound, a warning light signal, or a popup window containing a warning message. The production factory owner evaluates the profits from producing and delivering the parts on time. When the profits outweighs the extra cost from consuming more power than the upper threshold value, the production factory owner enters commands in the computer 210 to send instructions to the computer numerical controllers 232 in the machine tools 230 to execute the numerical control programs to produce the parts.

In another embodiment, the schedule is a working schedule including the numerical control programs to be executed by the machine tools 230 during a month, and the upper threshold value is a power consumption threshold value for the month. The computer 210 is configured for generating the execution schedule and the power consumption estimate associated with the execution schedule and transmits the execution schedule to the computer numerical controllers 232, so as to get a total power consumption value for the month to be below the power consumption threshold value in the energy contract. Moreover, the computer 210 is configured for generating a warning for the production factory owner to evaluate the profits when the total power consumption value for the month exceeds the power consumption threshold value.

The data in the power consumption database 220 is updated real-time while the numerical control programs are executed by the machine tools 230, so as to further improve the accuracy of the power consumption estimates generated by the machine tool power consumption prediction system 200. While the numerical control programs are executed by the machine tools 230, the computer 210 is configured for receiving the values of the machining parameters from the computer numerical controllers 232 and electricity consumption from the electricity meters 236 and storing the values of the machining parameters and the electricity consumption in the power consumption database 220. Furthermore, the computer 210 is configured for integrating the real-time data from the machines tools 230 and the electricity meters 236 with the power consumption data stored in the power consumption database 220 with statistical analysis or machine learning algorithms. The accuracy of the power consumption estimates generated by the machine tool power consumption prediction system 200 is improved by the aforesaid mechanism.

The machine tool power consumption prediction system 200 is also configured for continuously monitoring the electricity usage of the machine tools 230 with the electricity meters 236 and providing recommended values for the machining parameters to reduce the power consumption of producing parts when the power consumption estimate associated with one of the machine tools 230 or the total power consumption estimate associated with all of the machine tools 230 exceed the upper threshold value. In one embodiment, the computer 210 includes the upper threshold value associated with a time interval. The computer 210 is configured for generating an accumulative sum of the electricity consumption read from the electricity meters 236 from a start time of the time interval and adding the power consumption estimate from a current time to an end time of the time interval to the accumulative sum to generate the total power consumption estimate associated with the time interval. When the total power consumption estimate exceeds the upper threshold value, the computer 210 is configured for providing recommended values for the machining parameters included in the numerical control programs to be executed, so as to reduce the total power consumption estimate to be lower than the upper threshold value. The total power consumption estimate is obtained from adding the power consumption estimate from a current time to an end time of the time interval to the accumulative sum. For example, the power consumption data is 5 kW for the aforesaid second numerical control program with the spindle speed as 0-300 rpm and the time for producing one piece as 3 minutes, and 12 kW with the spindle speed as 300-600 rpm and the time for producing one piece as 2 minutes. When the second numerical control program is scheduled to be executed with the spindle speed as 300-600 rpm and the power consumption estimate associated exceeds the upper threshold value, the recommended value for the spindle speed is generated as 0-300 rpm, so as to reduce the power consumption of executing the second numerical control program to get the power consumption estimate to be lower than the upper threshold value.

Moreover, the production factory owner can also reduce the electricity cost with the machine tool power consumption prediction system 200 and the price difference between peak and off-peak time specified by the electricity providers. Illustratively, the computer 210 includes data of time-of-use rates, and is configured for obtaining the schedule and the numerical control programs to be executed associated with the machine tools 230. The computer 210 is configured for generating the execution schedule for decreasing the electricity cost according to the schedule, the numerical control programs to be executed, the data of the time-of-use rates, and the power consumption estimates associated with the numerical control programs to be executed, respectively.

To sum up, the machine tool power consumption prediction system 100/200 is configured for generating accurate power consumption estimates according to the values of the machining parameters included in the numerical control programs and updating the power consumption database 120/220 in real-time while the numerical control programs are executed to improve the accuracy of the power consumption estimates continuously. Moreover, the power consumption estimates generated are utilized for generating the execution schedule to meet the condition in the energy contracts to effectively manage production cost.

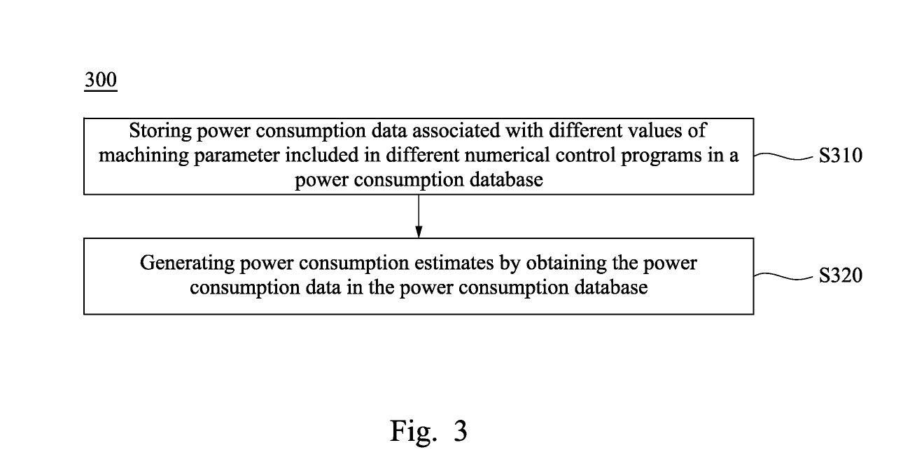

FIG. 3 is flow chart of a machine tool power consumption prediction method according to a third embodiment of the present disclosure. For convenience and clarity of explanation, the following detailed description for the machine tool power consumption prediction method 300 takes the machine tool power consumption prediction system 100 as an example, but the present disclosure is not limited thereto. The machine tool power consumption prediction method 300 is for predicting the power consumption for one or more machine tools 130, and the machine tools 130 are configured for executing one or more numerical control programs to produce parts. Each of the numerical control programs includes multiple machining parameters.

In operation S310, the power consumption database 120 is configured for storing power consumption data associated with values of the machining parameters included in the numerical control programs. Details of the power consumption data stored in the power consumption database 220 are given in the accompanying text of FIG. 1, and not repeated herein.

In operation S320, power consumption estimates associated with the numerical control programs are generated by obtaining the power consumption data associated with the values of the machining parameters from the power consumption database 220 according to the values of the machining parameters included in the numerical control programs to be executed by the machine tools 130. Details of searching the power consumption database 120 to generate the power consumption estimates associated with the numerical control programs are given in the accompanying text of FIG. 1, and not repeated herein.

The power consumption estimates associated with each of the numerical control programs to be executed are generated according to the values of the machining parameters included in the numerical control programs with the operation S310-S320 of the machine tool power consumption prediction method 300. The managers can make electricity usage plans with the accurate power consumption estimates.

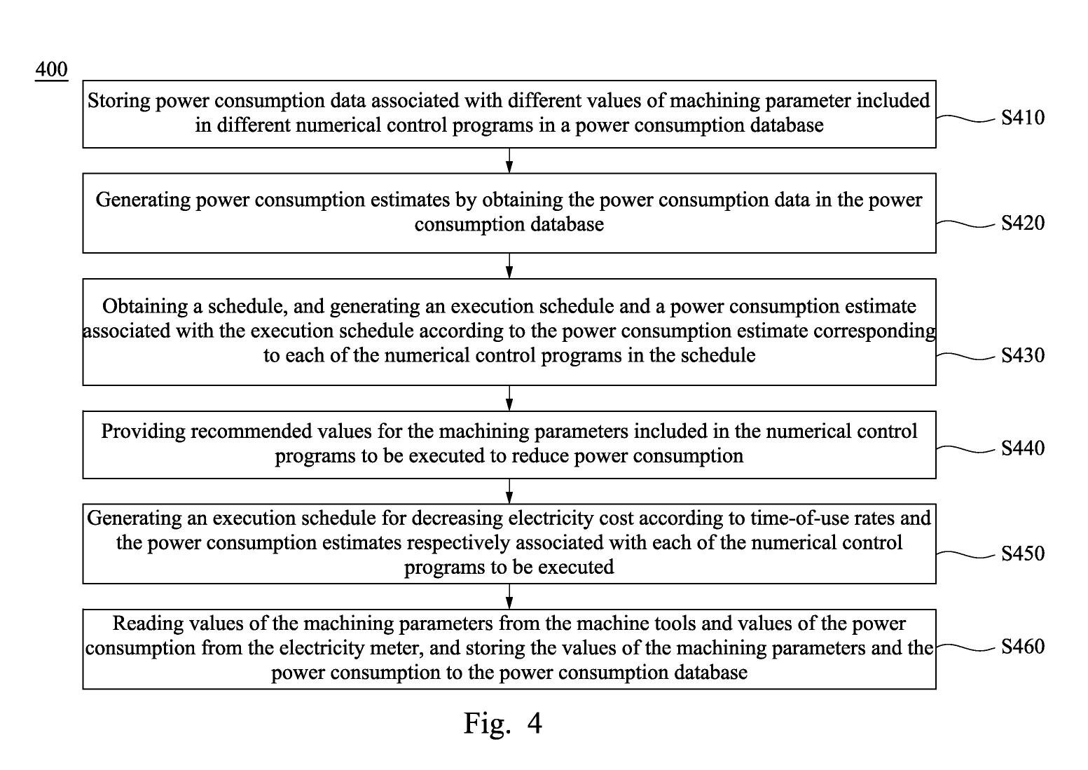

FIG. 4 is flow chart of a machine tool power consumption prediction method according to a fourth embodiment of the present disclosure. For convenience and clarity of explanation, the following detailed description for the machine tool power consumption prediction method 400 takes the machine tool power consumption prediction system 200 as an example, but the present disclosure is not limited thereto. While the process flow described below includes a number of operations that appear to be in a specific order, it should be apparent that these operations may include more or fewer operations, which may be executed serially or in parallel (e.g., using parallel processors or in a multi-threading environment). Moreover, details of operations S410-S420 are identical to the operations S310-S320 of the machine tool power consumption prediction method 300, and not repeated herein.

In operation S430, a schedule associated with the machine tools 230 is obtained from a manufacture order scheduling system 240, and the schedule includes parts to be produced and the numerical control programs associated with the parts. The schedule, the numerical control programs to be executed, the upper threshold value, and the power consumption estimates corresponding to the schedule and the numerical control programs to be executed are used to generate an execution schedule and the power consumption estimate associated with the execution schedule.

In one embodiment, the schedule obtained from the manufacture order scheduling system 240 in the operation S430 is a working schedule including the numerical control programs to be executed during a day, and the upper threshold value is a power consumption threshold value for every 15-minute interval. The execution schedule is generated for getting a total power consumption value of every 15-minutes interval to be below the power consumption threshold value while the numerical control programs are executed by the machine tools 230.

In another embodiment, the schedule obtained from the manufacture order scheduling system 240 in the operation S430 is a working schedule including the numerical control programs to be executed during a month, and the upper threshold value is a power consumption threshold value for the month. The execution schedule is generated for getting a total power consumption value of the month to be below the power consumption threshold value during the execution of the numerical control programs to be executed by the machine tools 230.

With the operation S430, the manager of the production factory controls an instantaneous power consumption value to be lower than the upper threshold value (e.g., the power consumption threshold value for every 15-minute interval), and the power consumption value of the month to be lower than the upper threshold value in the energy contract with the electricity provider (e.g., power consumption threshold value for the month) to avoid being fined. In yet another embodiment, when the power consumption value is not to be lower than the power consumption threshold value for the month, a warning is generated to inform the manager of the production factory.

In operation S440, when a total power consumption estimate exceeds the upper threshold value associated with a time interval, recommended values for the machining parameters are provided to reduce the total power consumption estimate. Illustratively, an accumulative sum of the electricity consumption read from the electricity meter from a start time of the time interval to a current time is generated, and the accumulative sum is added with the power consumption estimate from the current time to an end time of the time interval to generate the total power consumption estimate associated with the time interval. When the total power consumption estimate exceeds the upper threshold value associated with the time interval, the recommended values for the machining parameters are provided to reduce power consumption of producing the part, so as to reduce the total power consumption estimate from adding the power consumption estimate from a current time to an end time of the time interval to the accumulative sum to be lower than the upper threshold value. Details of the operation S440 are given in the accompanying text of FIG. 2, and not repeated herein.

The electricity providers provide the electricity at a lower price during off-peak hour than peak hour. Accordingly, the execution schedule for decreasing electricity cost is generated in operation S450 according to the numerical control programs to be executed in the schedule obtained from the manufacture order scheduling system 240, data of time-of-use rates, and the power consumption estimate associated each of the numerical control programs to be executed, respectively. Details of the operation S450 is given in the accompanying text of FIG. 2, and not repeated herein.

In operation S460, the computer 210 is configured for receiving the values of the machining parameters from the computer numerical controllers 232 and electricity consumption from the electricity meters 236 and storing the values of the machining parameters and the electricity consumption in the power consumption database 220 while the numerical control programs are executed by the machine tools 230. Illustratively, the power consumption data associated with the values of the machining parameters included in the numerical control programs stored in the power consumption database 220 are added, modified, and updated to improve the accuracy of the power consumption estimate made with the machine tool power consumption prediction method 400.

The machine tool power consumption prediction method 300/400 is configured for generating accurate power consumption estimates according to the values of the machining parameters included in the numerical control programs and updating the power consumption database 120/220 in real-time while the numerical control programs are executed to improve the accuracy of the power consumption estimates continuously. Moreover, when the factory is at full production capacity and rearranging the schedule does not lower the power consumption estimates, the machine tool power consumption prediction method 300/400 are utilized to provide the recommended values for the machining parameters to further lower the power consumption values, so as to manage the cost.

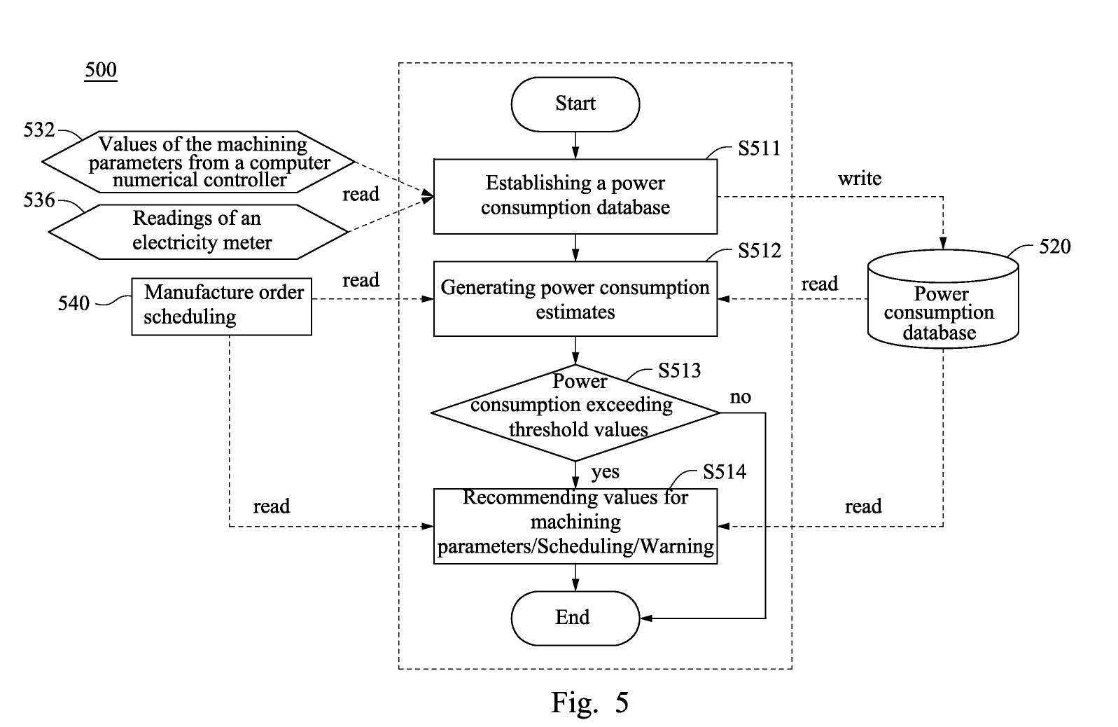

FIG. 5 is a schematic diagram of a machine tool power consumption prediction system according to a fifth embodiment of the present disclosure. Transmission of data among the components is emphasized in FIG. 5. For clarity of explanation, identical terms are used to name the components with similar or identical function in the previous embodiments. The machine tool power consumption prediction system 500 includes a computer 510, a power consumption database 520, multiple machine tools 530, electricity meters 536, and a manufacture order scheduling system 540. The connection and interoperation among the components are similar to the previous embodiments, and are not detailed herein. The computer 510 includes a processor and a storage device, and software including one or more instructions is stored in the storage device. The processor executes the instructions to perform operation S511-S514.

In operation S511, the power consumption database 520 is established. When numerical control programs are executed by the machine tools 530, the computer 510 is configured for recording identification of the numerical control programs (e.g., serial number or name) and reading values of the machining parameters from the computer numerical controllers 532 in the machine tools 530 and electricity consumption from the electricity meters 536. The computer 510 is also configured for storing the identification of the numerical control programs, the values of the machining parameters from the machine tools 530, and the electricity consumption from the electricity meters 536 in the power consumption database 520. When the machine tools 530 are configured for executing the numerical control programs afterwards, a power consumption estimate is generated accurately with the power consumption data from the power consumption database 520. Moreover, the computer 510 is configured for continuously monitoring the power consumed by the machine tools 530 connected to the computer 510 by reading electricity consumption from the electricity meters 536.

In operation S512, the computer 510 is configured for receiving a schedule for a day or a month from the manufacture order scheduling system 540. The schedule includes multiple manufacture orders, and each of the manufacture orders further includes name and quantity of the parts to be produced. Each of the parts is associated with one or more numerical control programs. For example, the content of the manufacture order says 1,000 pieces of screws to be produced, and the computer 510 records that a third numerical control program and a fourth numerical control program are associated with the screws, and also records the values of the machining parameters included in the third numerical control program and the fourth numerical control program for producing the screws. Therefore, the computer 510 is configured for searching the power consumption database 520 with the values of the machining parameters included in the third numerical control program to obtain the power consumption data associated with the third numerical control program and the values of the machining parameters included in the fourth numerical control program to obtain the power consumption data associated with the fourth numerical control program. The power consumption data are then added together and multiplied with the quantity specified in the manufacture order to generate the power consumption estimate associated with the manufacture order. The computer 510 is further configured for adding the power consumption data associated with each of the manufacture orders during a day together to obtain the power consumption estimate of the day. The power consumption estimate of a month is obtained in a similar manner, and the details are not repeated herein.

The computer 510 is configured for executing the instructions to perform operation S513. The computer 510 includes multiple upper threshold values associated with different time intervals and checking whether sums of the power already consumed by the machine tools 530 and power consumption estimates associated with the time intervals exceed the upper threshold value associated with the time intervals respectively. When none of the sums exceeds the upper threshold values, the machine tools 530 is configured for executing the numerical control programs to be executed included in the schedule.

In one embodiment, the upper threshold value is a power consumption threshold value for a 15-minute interval. In another embodiment, the production factory owner signs a long-term energy contract with the electricity provider, and an upper threshold value for a certain time interval (e.g., a month) is stated in the energy contract. When the total power consumption estimate for the time interval exceeds the upper threshold value, the computer 510 is configured for executing the instructions to perform operation S514.

In operation S514, the computer 510 is configured for providing recommended values of the machining parameters included in the numerical control programs to be executed, and the recommended values are associated with smaller values of the power consumption data in the power consumption database 520. The computer 510 is configured for transmitting the recommended values to the computer numerical controllers 532 in the machine tools 530, so as to execute the numerical control programs with the machining parameters as the recommended values. Moreover, the power already consumed by the machine tools 530 plus the power consumption estimates associated with the recommended values of the machining parameters in the numerical control programs to be executed is lower than the upper threshold value in the computer 510.

In one embodiment, the computer 510 is configured for generating an execution schedule, so as to get the power consumption estimate associated with the execution schedule plus the power already consumed by the machine tools 530 to be lower than the upper threshold value. For example, the computer 510 is configured for reading delivery dates in the manufacture orders and postponing the manufacture orders with the delivery dates later than end of the month to the next month.

In another embodiment, the recommended values are provided and the execution schedule is generated, but the power consumption estimates is still not to be lower than the upper threshold values. The computer 510 is configured for generating a warning for the production factory owner, and the production factory owner evaluates profits earned by delivering the produced parts on time. When the profits are higher than the extra electricity cost from exceeding the upper threshold values, the factory owner enters a command, so as to make the computer 510 transmit a command to the computer numerical controllers 532 in the machine tools 530 to continue executing the numerical control programs to produce parts.

In conclusion, the disclosure provides a machine tool power consumption prediction system and method to overcome the disadvantages of the conventional way of monitoring the total electricity usage of the production factories as a whole. A power consumption database is established to generate accurate power consumption estimates according to values of machining parameters included in numerical control programs. Furthermore, recommended values of the machining parameters are provided when the power consumption estimates exceed upper threshold values to avoid interrupting the production process. The accurate power consumption estimates enable the production factory owners to make energy plans according to detailed information. Moreover, the power consumption data in the power consumption database is updated real-time while the numerical control programs are executed, so as to improve the accuracy with time. Lastly, the power consumption estimates are utilized for generating execution schedules that saves electricity cost to manage the production cost precisely.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of the present disclosure provided they fall within the scope of the following claims.

What is claimed is:

1. A machine tool power consumption prediction system for predicting power consumption for at least one machine tool, wherein the machine tool is configured for executing at least one numerical control program including a plurality of machining parameters to produce a part, comprising:
a power consumption database storing a plurality of power consumption data associated with values of the machining parameters included in the numerical control program; and
a computer electrically connected with the power consumption database, wherein the computer is configured for generating a power consumption estimate associated with the numerical control program by obtaining the power consumption data associated with the values of the machining parameters from the power consumption database according to the values of the machining parameters included in the numerical control program to be executed by the machine tool.

2. The machine tool power consumption prediction system as claimed in claim 1, wherein the at least one machine tool includes a plurality of machine tools, the computer includes an upper threshold value and is connected to a manufacture order scheduling system to obtain a schedule associated with the machine tools and the numerical control programs to be executed by the machine tools, and the computer is configured to generate an execution schedule and the power consumption estimate associated with the execution schedule according to the schedule, the numerical control programs to be executed, the upper threshold value, and the power consumption estimate corresponding to the schedule and the numerical control programs to be executed.

3. The machine tool power consumption prediction system as claimed in claim 2, wherein the schedule is a working schedule including the numerical control programs to be executed by the machine tools within a day, the upper threshold value is a power consumption threshold value for every 15-minute interval, and the computer is configured for generating the execution schedule and the power consumption estimate associated with the execution schedule to get a total power consumption value during every 15-minute interval to be below the power consumption threshold value and generating a warning when the total power consumption value during every 15-minute intervals is not to be below the power consumption threshold value.

4. The machine tool power consumption prediction system as claimed in claim 2, wherein the schedule is a working schedule comprising the numerical control programs to be executed by the machine tools during a month, the upper threshold value is a power consumption threshold value for the month, the computer is configured for generating the execution schedule and the power consumption estimate associated with the execution schedule to get a total power consumption value during the month to be below the power consumption threshold value and generating a warning when the total power consumption value during the month is not to be below the power consumption threshold value.

5. The machine tool power consumption prediction system as claimed in claim 1, wherein the at least one machine tool includes a plurality of machine tools, the computer includes a plurality of data of time-of-use rates and is electrically connected with a manufacture order scheduling system to obtain a schedule associated with the machine tools and the numerical control programs to be executed, and the computer is configured for generating an execution schedule for decreasing electricity cost according to the schedule, the numerical control programs to be executed, the data of time-of-use rates, and the power consumption estimates respectively associated with the numerical control programs to be executed.

6. The machine tool power consumption prediction system as claimed in claim 1, wherein the machine tool is electrically connected with an electricity meter, and the computer is configured for receiving the values of the machining parameters from the machine tool and an electricity consumption from the electricity meter and storing the values of the machining parameters and the electricity consumption in the power consumption database while the numerical control program is executed by the machine tool.

7. The machine tool power consumption prediction system as claimed in claim 6, wherein the computer comprises an upper threshold value associated with a time interval and is electrically connected with a manufacture order scheduling system to obtain a schedule associated with the machine tool and the numerical control program to be executed; the computer is configured for generating an accumulative sum of the electricity consumption read from the electricity meter from a start time of the time interval to a current time, adding the power consumption estimate from the current time to an end time of the time interval to the accumulative sum to generate a total power consumption estimate associated with the time interval; when the total power consumption estimate exceeds the upper threshold value, the computer is configured to provide recommended values for the machining parameters included in the numerical control program to be executed to reduce power consumption of producing the part and made the total power consumption estimate obtained from adding the accumulative sum to the power consumption estimate from a current time to an end time of the time interval to be below the upper threshold value.

8. The machine tool power consumption prediction system as claimed in claim 1, wherein the machining parameters comprise a spindle speed, a feed rate, and depth of cut.

9. A machine tool power consumption prediction method for predicting power consumption for at least one machine tool, wherein the machine tool is configured for executing at least one numerical control program including a plurality of machining parameters to produce a part, comprising:
storing a plurality of power consumption data associated with values of the machining parameters included in the numerical control program in a power consumption database; and
generating a power consumption estimate associated with the numerical control program by obtaining the power consumption data associated with the values of the machining parameters from the power consumption database according to the values of the machining parameters included in the numerical control program to be executed by the machine tool.

10. The machine tool power consumption prediction method as claimed in claim 9, wherein the at least one machine tool includes a plurality of machine tools, further comprising:
obtaining a schedule associated with the machine tools and the numerical control programs to be executed by the machine tools from a manufacture order scheduling system; and
generating an execution schedule and the power consumption estimate associated with the execution schedule according to the schedule, the numerical control programs to be executed, the upper threshold value, and the power consumption estimate corresponding to the schedule and the numerical control programs to be executed.

11. The machine tool power consumption prediction method as claimed in claim 10, further comprising:
generating the execution schedule and the power consumption estimate associated with the execution schedule to get a total power consumption value during every 15-minute interval to be below a power consumption threshold value, and generating a warning when the total power consumption value during every 15-minute interval is not to be below the power consumption threshold value, wherein the schedule is a working schedule including the numerical control programs to be executed by the machine tools within a day, and the upper threshold value is the power consumption threshold value for each of the 15-minute intervals.

12. The machine tool power consumption prediction method as claimed in claim 10, further comprising:
generating the execution schedule and the power consumption estimate associated with the execution schedule to get a total power consumption value during a month to be below a power consumption threshold value, and generating a warning when the total power consumption value during the month is not to be below the power consumption threshold value, wherein the schedule is a working schedule including the numerical control programs to be executed by the machine tools during the month, and the upper threshold value is a power consumption threshold value for the month.

13. The machine tool power consumption prediction method as claimed in claim 9, further comprising:
obtaining a schedule associated with the machine tools and the numerical control programs to be executed by the machine tool, wherein the at least one machine tool includes a plurality of machine tools; and
generating an execution schedule for decreasing electricity cost according to the schedule, the numerical control programs to be executed, data of time-of-use rates, and the power consumption estimates respectively associated with each of the numerical control programs to be executed.

14. The machine tool power consumption prediction method as claimed in claim 9, further comprising:
receiving the values of the machining parameters from the machine tool and electricity consumption from an electricity meter connected with the machine tool, and storing the values of the machining parameters and the electricity consumption in the power consumption database while the numerical control program is executed.

15. The machine tool power consumption prediction method as claimed in claim 14, further comprising:
obtaining a schedule associated with the machine tool and the numerical control program to be executed by the machine tool from a manufacture order scheduling system; and
receiving an upper threshold value associated with a time interval, generating an accumulative sum of the electricity consumption read from the electricity meter from a start time of the time interval to a current time, adding the power consumption estimate from the current time to an end time of the time interval to the accumulative sum to generate a total power consumption estimate associated with the time interval, and when the total power consumption estimate exceeds the upper threshold value, providing recommended values for the machining parameters included in the numerical control programs to be executed to reduce power consumption of producing the part and get the total power consumption estimate obtained from adding the accumulative sum to the power consumption estimate from a current time to an end time of the time interval to be below the upper threshold value.

16. The machine tool power consumption prediction method as claimed in claim 9, wherein the machining parameters comprise a spindle speed, a feed rate, and depth of cut.
